(19) United States
(12) Patent Application Publication
(10) Pub. No.: US 2018/0116461 A1
(43) Pub. Date: May 3, 2018

(54) Espresso Milk Frothing Pitcher with One or More Heat Resistant Silicone Pads

(71) Applicant: Espriazza, L.L.C., Bryn Mawr, PA (US)

(72) Inventor: Sam Chan, Jiangmen (CH)

(21) Appl. No.: 15/802,010

(22) Filed: Nov. 2, 2017

Related U.S. Application Data
(60) Provisional application No. 62/416,552, filed on Nov. 2, 2016.

(51) Int. Cl. A47J 41/00; A47J 31/44

(52) U.S. Cl. CPC A47J 41/0094; A47J 31/4496

(57) ABSTRACT

An improved pitcher for making an espresso comprises a metal body having a top rim opening through which to feed a liquid and a pour spout; a handle attachment area; and a plurality of heat resistant silicone pads for adhering to one or more sides of the metal body, said silicone pads displaying as a first color at or below a first temperature and as a second color, distinguishable from the first color, at or above the first temperature. A method for making espressos with that pitcher is also disclosed.

### CROSS-REFERENCE TO RELATED APPLICATION

This is a perfection of U.S. Provisional Application Ser. No. 62/416,552, filed on Nov. 2, 2016, the disclosure of which is fully incorporated by reference herein.

### BACKGROUND OF THE INVENTION

### 1. Field of the Invention

The present invention relates to accessories useful in the making of espresso coffees and other like beverages. Particularly, it pertains to a pitcher that can be safely held about its sides while at an elevated temperature.

### 2. Description of the Prior Art

The use of metal pitchers in the making of espresso drinks is well known. What is not known is how to quickly yet safely indicate to baristas when the contents of a standing pitcher are at an acceptable temperature for pick up and/or at the proper temperature for mixing the pitcher's contents with other additives to fill a customer's beverage order. Most often, one or more thermometers are kept about for placing into or across the upper rim of one or more pitchers to better gauge when their contents are at a preferred temperature for further use. What is desired is an easier, yet rapid way for determining when a pitcher's contents are sufficiently cool or too hot to pick up and/or use. Preferably, such a determination would include a visual indicator component. This invention meets that stipulated need in the espresso industry.

### SUMMARY OF THE INVENTION

The preferred holding means includes a plurality of heat resistant pads that will not conduct the potentially harmful temperatures of a metal pitcher's contents to the hands of the person carrying/using the pitcher, i.e., the barista or the like. Preferably, these pads can be made from color-indicating materials so as to visually warn those approaching a standing pitcher that its contents are either safe to pick up or, better still, at the preferred/proper temperature for using (i.e., mixing with other contents in a customer's beverage order).

It is therefore an object of the present invention to provide a new and improved espresso pitcher that has a plurality, preferably two or more, heat resistant silicone pads adhered to and wrapped at least partially about the pitcher's main body, said pads serving as means for safely picking up the pitcher for use without risk of being burned.

It is another object to provide such pitcher silicone pads with a visual temperature indication means (preferably via a noticeable color change) to show users/baristas when a standing pitcher is at temperature, or needs replacing/reheating.

It is another object of this invention to provide a new and improved metal pitcher that may be easily and efficiently manufactured and marketed.

The present invention consists of a metal pitcher with a plurality of (preferably two or more on opposed sides) silicone pads permanently affixed thereto. The silicone pads do not conduct heat but change color depending on the temperature of the container exterior to which they are affixed. Ideally, this color change serves as a visual indicator of the container's contents temperature. In addition to a color change, one or more logos may become visible depending on a container's content temperatures.

The objects of this invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings in which:

FIG. 1 is a front plan view of a representative espresso pitcher with side silicone pads according to one embodiment of this invention;

FIG. 2 is a right side view of the espresso pitcher from FIG. 1;

FIG. 3 is a top perspective view of the espresso pitcher from FIGS. 1 and 2;

FIGS. 4A through C show rear perspective views of this same pitcher with 4A showing a first pad color, i.e. before hot liquids have been placed therein; 4B showing, in top view, a thermometer for indicating the temperature of an internal liquid added to the inside of this same pitcher; and 4C showing the silicone pad color change resulting from the addition of a hot liquid to that same pitcher;

FIG. 5A is a rear perspective view of a first alternative embodiment of pitcher, with a color-indicating logo, according to this invention; and

FIG. 5B is a rear perspective view of a second alternative embodiment, with a temperature-warning indicator included.

### DESCRIPTION OF PREFERRED EMBODIMENTS

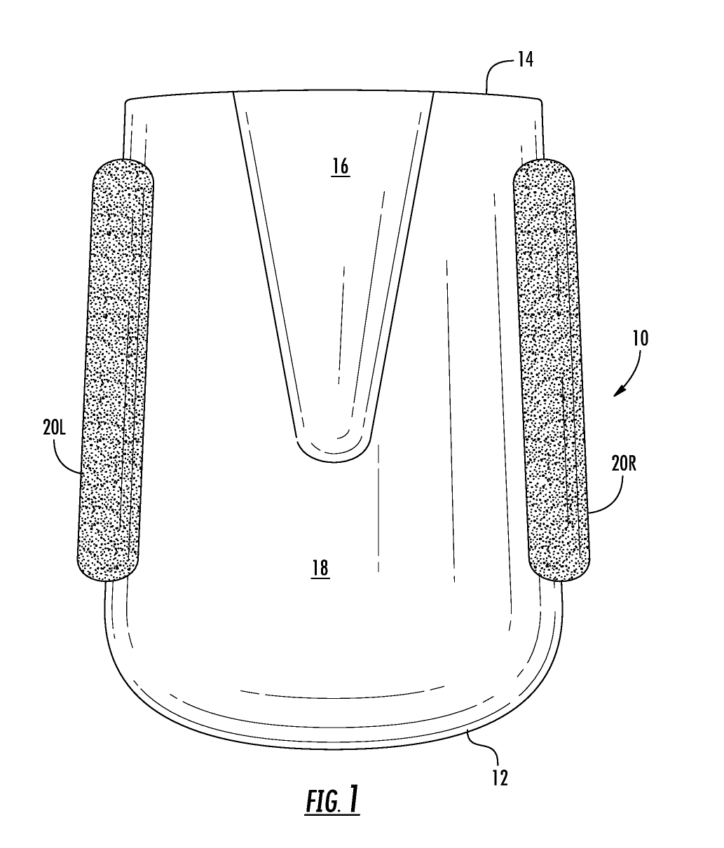

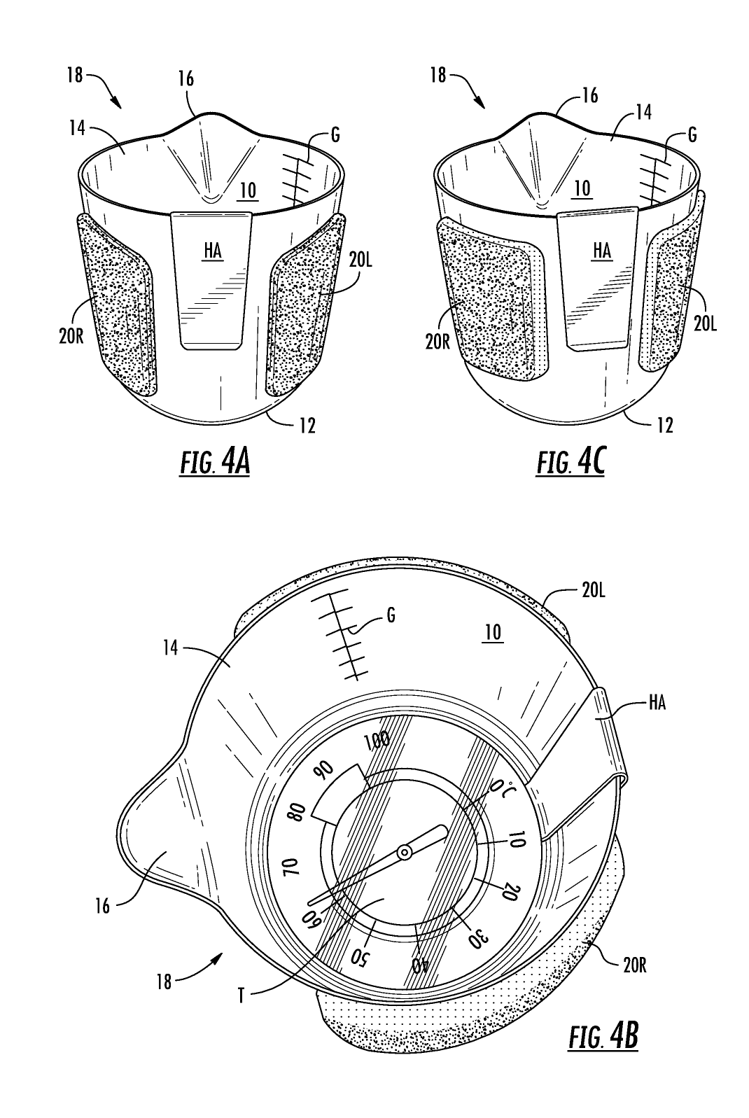

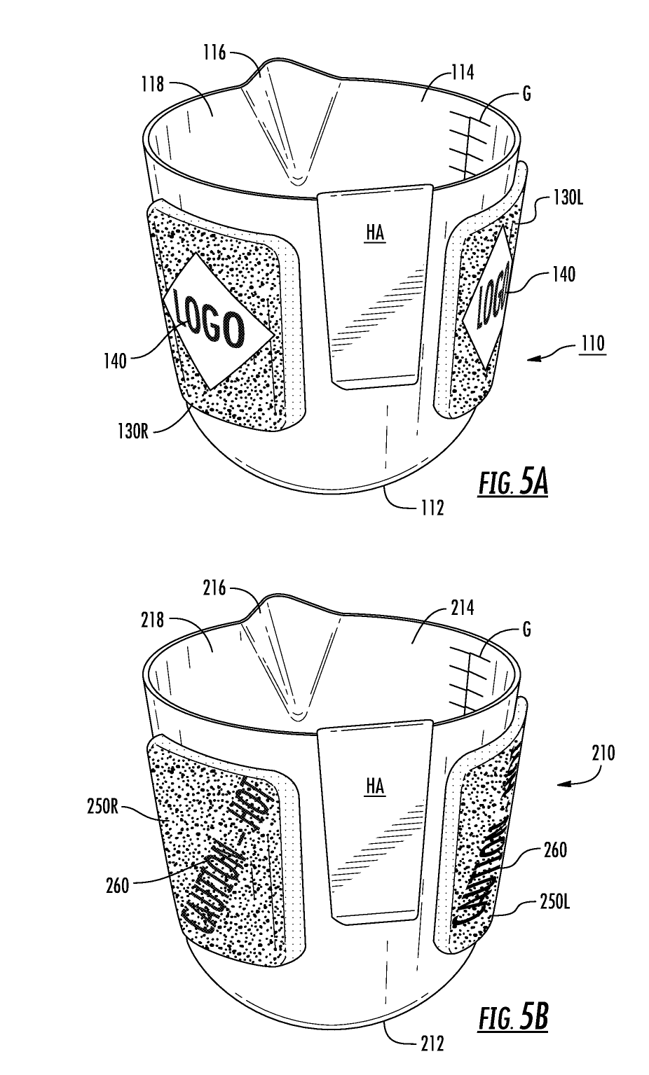

With reference to the accompanying drawings, and in particular the first embodiment at FIGS. 1 through 4C, there is shown a representative espresso pitcher 10, somewhat cylindrically shaped but with a lower resting base 12, an upper open filling end 14 and a pouring spout 16 closer to a front face 18 of the main pitcher body. A representative gradient scale G is included along an interior wall of pitcher 10 for showing the barista the precise amount of liquids contained in pitcher 10. Depending on the overall size of the pitcher, some versions may add a pouring handle opposite pouring spout 16 though none of these versions have included such a handled alternative. One such place for including such a carrier would be handle area HA in FIGS. 4A through C and both FIG. 5 alternatives.

Next, FIGS. 1 through 3 show a first variation of temperature-indicating silicone pad additions to the standard espresso pitcher per the present invention. Particularly, there is a plurality, at least one if done as a fuller wrap around gripping pad, but more preferably two silicone pads, 20L and 20R on the left and right sides of spout 16 in this first variation. These pads are made from a material especially designed to change colors, at least two different shades, depending on the temperatures of the liquids being held in the main body of pitcher 10. One preferred variation would rapidly, yet noticeably change from a first color pad when the pitcher is empty, or contains a colder espresso ingredient. But, when that same pitcher has a sufficient quantity of hotter material(s) stored therein, these same pads 20L and R will both purposefully morph into a second color pad, more indicative of the hotter pitcher contents.

One representative color changing is evidenced in FIGS. 4A through C. Particularly therein, pitcher 10 starts with black-colored silicone pads 20L and R per the color lining for said pads in FIG. 4A. Then, with the addition of a hotter liquid into the pitcher interior, as evidenced by the 62° C. reading on thermometer T in FIG. 4B, both pads will change from their first, colder color indication (i.e., black) to one of a more greyer tone (per the lining in FIG. 4C). In FIG. 4B, there is a single stem thermometer for inserting into the open end 14 of pitcher 10. Still other variations may include a stick thermometer that rests on, clips to or otherwise connects to both (opposed) sides of that open end so as to serve as a diametric thermometer connection . . . usually adjustable in total width.

It should be noted that multiple color changes may also be indicated with improvements in silicone (or other material) padding. For example, one might actually vary from Black pads for a cold or empty pitcher, to Dark Gray for Warmer contents, to a much lighter grey, almost White, for a third temperature color indication of “Too Hot to Touch” without hand protection or gloves. Alternately, a third color could be used to notify the barista that his/her pitcher's contents are now at an optimum temperature for mixing and/or serving.

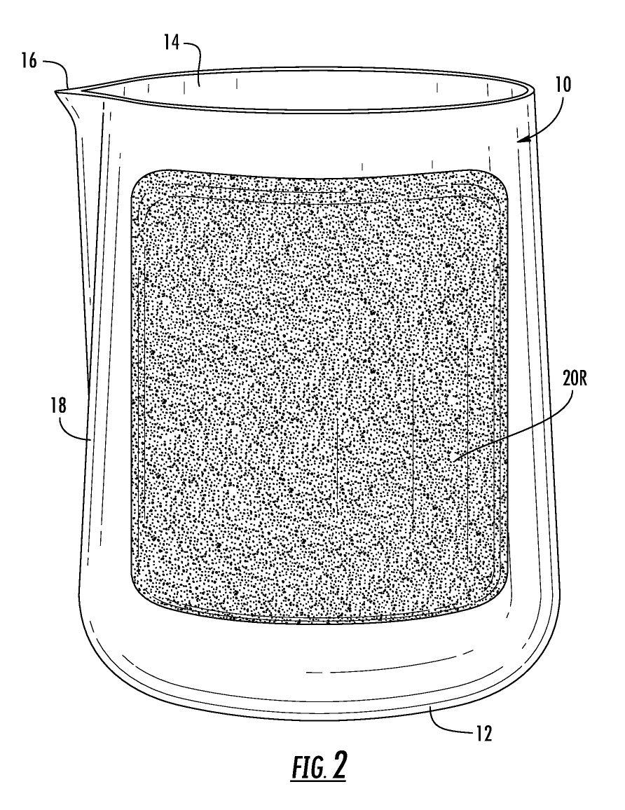

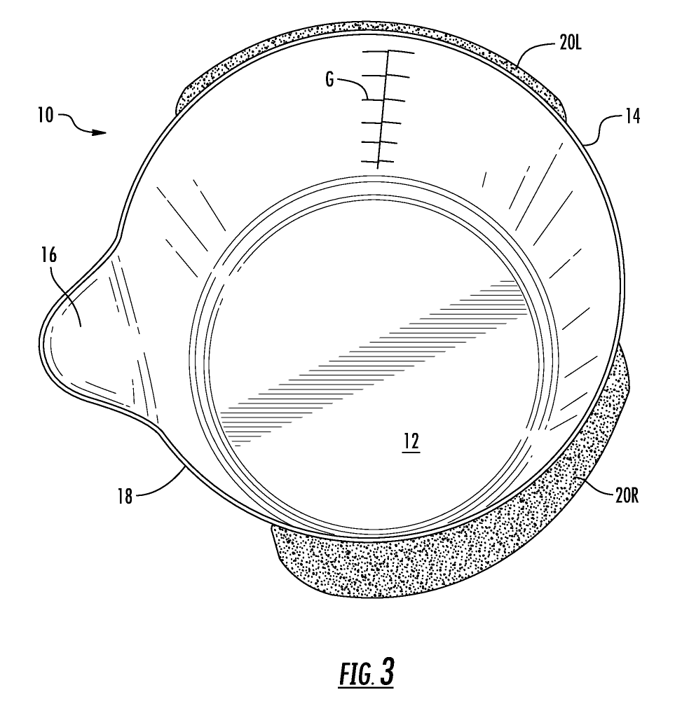

Note from the front (FIG. 1), side (FIG. 2) and top (FIG. 3) views how a preferred variation includes two silicone pads, one on each of the opposed sides—said pads serving as means for gripping the pitcher by the barista. Optionally, a rear handle (not shown) may still be included though not required, especially for smaller sized pitchers. In another alternative, three or more such silicone pads may be situated about the perimeter of the pitcher's main body. Or, when no interfering/interrupting pitcher's handle is included, the invention may consist of one longer, more continuous pad that wraps about 250-270 degrees around the pitcher's body proper—so long as the pad(s) leaves room for (i.e., doesn't interfere with or pass under any portion of the pitcher body) the pouring spout at one end of the upper rim to this pitcher body proper.

The sizes and relative shapes of each espresso pitcher may vary—particularly when factoring barista preferences into account. It is the essence of THIS invention that each pitcher be fitted with heat insulating silicone shields (or pads). More preferably, these pads would be made of material that would be color indicative of the temperature of the pitcher's contents.

Referring now to FIGS. 4A through C, there is sequentially shown how one preferred embodiment of this invention operates. At the upper left corner, there is shown an espresso pitcher 10 with its pair of silicone pads 20L and R affixed to the sides, along both sides of pour spout 16. Before any addition of hot liquids to that pitcher 10, pads 20L and R are shown in the silicone's “original” black color.

When the contents of pitcher 10 raise its external temperature above about 60° C./140° F., the color of the side pads 20L and R will lighten, or change from black to gray in this exemplary instance as best seen in FIG. 4C. It should be noted that the aforementioned color change is NOT a one-time occurrence/indicator. Rather, when the temperature of the espresso pitcher (and its contents, if not emptied) returns to below 60° C./140° F., the darkened or black color of these pads will return.

For alternative variations of this invention, common elements are commonly numbered though in the next hundred series. In still other variations, temperature indicating silicone pads may be used in other than the black-to-gray range. For example, for the pitcher 110 in FIG. 5A, there may be imparted onto pads 130L and R a corporate name/trademark or Logo 140 that would either disappear, OR only become visible, when a preferred temperature of the contents has been met or exceeded. FIG. 5B offers a third alternative for its pitcher 210 whereby the adjoining pads 250L and R have a temperature warning indicator 260 that would only appear when the contents are too hot to otherwise hold unprotected.

A method for making espresso using one of the aforementioned pitchers is also disclosed. It entails providing one of said pitchers and then observing the pad colors to proceed according to the temperatures indicated therewith.

Having described the presently preferred embodiments, it is to be understood that the invention may be otherwise covered by the scope of the appended claims.

What is claimed is:

1. An espresso pitcher comprising:
a metal body having a top rim opening through which to feed a liquid and a pour spout; and
a plurality of heat resistant pads adhered to one or more sides of the metal body with the pour spout there between.

2. The espresso pitcher of claim 1 wherein the heat resistant pads are made from a material that displays as a first color at a first lower temperature and as a second color, distinguishable from the first color, when the liquid in the metal body is at a higher temperature.

3. The espresso pitcher of claim 1, which further includes a handle attachment area.

4. The espresso pitcher of claim 1 wherein there are two separate heat resistant pads, one on either side of the handle attachment area.

5. The espresso pitcher of claim 2 wherein the material for the heat resistant pads includes a color-changing silicone.

6. The espresso pitcher of claim 5 wherein the silicone heat resistant pads remain black at one or more temperatures below about 60° C./140° F.

7. The espresso pitcher of claim 6 wherein the silicone heat resistant pads lighten to a gray color above about 60° C./140° F.

8. The espresso pitcher of claim 2 wherein the heat resistant pads include one or more names, logos or trademarks that are only visible at or below a certain temperature.

9. The espresso pitcher of claim 2 wherein the heat resistant pads each include a temperature warning that is only visible at or above a certain temperature.

10. The espresso pitcher of claim 9 wherein the temperature warning is only visible at or above about 60° C./140° F.

11. An improved pitcher for making an espresso, said pitcher comprising:
a metal body having a top rim opening through which to feed a liquid and a pour spout;
a handle attachment area; and
a plurality of heat resistant silicone pads for adhering to one or more sides of the metal body, said silicone pads displaying as a first color at or below a first temperature and as a second color, distinguishable from the first color, at or above the first temperature.

12. The improved pitcher of claim 11 wherein the silicone pads remain black at one or more temperatures below about 60° C./140° F., and lighten to a gray color above about 60° C./140° F.

13. The improved pitcher of claim 11 wherein there are two separate heat resistant pads, one on either side of the handle attachment area.

14. The improved pitcher of claim 11 wherein at least one of the silicone pads includes one or more names, logos or trademarks that are only visible at or below a certain temperature.

15. The improved pitcher of claim 11 wherein at least one of the silicone pads includes a temperature warning that is only visible at or above about 60° C./140° F.

16. An improved method for making espressos, said method comprising:
(i) providing a pitcher that comprises: (a) a metal body having a top rim opening through which to feed a liquid and a pour spout; (b) a handle attachment area; and (c) a plurality of heat resistant silicone pads for adhering to one or more sides of the metal body, said silicone pads displaying as a first color at or below a first temperature and as a second color, distinguishable from the first color, at or above the first temperature;
(ii) filling the pitcher with the liquid;
(iii) noticing the color of the silicone pads depending on the temperature of the liquid inside the pitcher; and
(iv) lifting the pitcher by the silicone pads so as to avoid being burned through contact with the pitcher for making espressos therewith.

17. The method of claim 16 wherein the silicone pads remain black at one or more temperatures below about 60° C./140° F., and lighten to a gray color above about 60° C./140° F.
